(19) United States
(12) Patent Application Publication
(10) Pub. No.: US 2012/0232970 A1
(43) Pub. Date: Sep. 13, 2012

(54) Intelligent postage stamp printer

(75) Inventor: Salim G. Kara, Thornhill (CA)

(73) Assignee: myiStamp Inc.

(21) Appl. No.: 13/373,757

(22) Filed: Nov. 29, 2011

Related U.S. Application Data
(60) Provisional application No. 61/418,347, filed on Nov. 30, 2010.

(51) Int. Cl. G07B 17/02; G06Q 30/02

(52) U.S. Cl. 705/14.4; 705/408

(57) ABSTRACT

A postage printing apparatus includes a user interface for accepting user input of postage criteria. The apparatus also includes a processor to process the user input to generate a postage request. A postage server communication module communicates the postage request to a remote postage server. The remote postage server returns data corresponding to postage indicia. The apparatus includes a printer for accepting instructions to print the postage indicia. The apparatus is in direct communication with the remote postage server without a separate computer performing any postage printing processing functionality.

### RELATED APPLICATIONS

This application claims the benefit of earlier filed provisional patent application Ser. No. 61/418,347 filed Nov. 30, 2010.

### TECHNICAL FIELD

The present disclosure generally relates to postage systems and postage stamp printer systems.

### BACKGROUND

A variety of systems are available to individuals and businesses for printing postage stamps directly. Some commercial business rent postage meters that can print postage meter marks (“franking”). This arrangement is very convenient, since letters may be addressed, postage applied, and mailed directly from all office without requiring an employee to physically visit the U.S. Post Office and wait in line in order to apply postage. Another service is the PC Postage service from the U.S. Postal Service that is provided by third parties for printing U.S. postage stamps on a user's printer. A computer connects and sends information to a postage server. Postage is paid for during this transaction and the postage server generates and returns a postage indicia or other information to the computer. The computer then creates and/or sends the postage indicia to a connected general-purpose printer and the bar-coded stamp is printed on an envelope or label. The postage indicia are known as “information based indicia (IBI),” “electronic stamps,” “interne postage,” “online postage,” “online stamps,” “digital stamps,” and “digital postage.”

### SUMMARY

In one embodiment, a postage printing apparatus is provided and includes a user interface operable to receive user input for generating a postage request. A processor is also included and is operable to process the user input to generate the postage request. A postage server communication module is in electronic communication with the processor and is operable to transmit the postage request to a remote postage server. The postage server communication module is operable to receive from the remote postage server postage data for creating postage indicia. A printer is in electronic communication with the postage server communication module and is operable to receive instructions to print the postage indicia.

In another embodiment, a postage printing apparatus includes a processor operable to receive postage criteria to generate the postage request. A postage server communication module is in electronic communication with the processor and is operable to transmit the postage request to a remote postage server. The postage server communication module is also operable to receive from the remote postage server postage data for creating a postage indicia. The postage server communication module is in direct Internet communication with the remote postage server. A printer is in electronic communication with the postage server communication module and is operable to receive instructions to print the postage indicia.

In another embodiment, a method of printing postage indicia is provided. The method includes receiving user input of one or more postage criteria. The one or more postage criteria are used to generate a postage request. The postage request is transmitted to a remote postage server. The method further includes receiving, from the postage server, postage indicia data and using the postage indicia data to print postage indicia.

### BRIEF DESCRIPTION OF THE DRAWINGS

FIG. 1 illustrates an example system for securely providing postage stamps;

FIG. 2 illustrates an example postage stamp printer;

FIG. 3 illustrates an example user interface;

FIG. 4 illustrates an example user interface;

FIG. 5 illustrates an example user interface;

FIG. 6 illustrates an example user interface;

FIG. 7 illustrates an example user interface;

FIG. 8 illustrates an example of indicia barcodes;

FIG. 9 illustrates an example computer system;

FIG. 10 illustrates an example network environment; and

FIG. 11 is a block diagram of a postage printing apparatus according to an example embodiment.

### DESCRIPTION OF EXAMPLE EMBODIMENTS

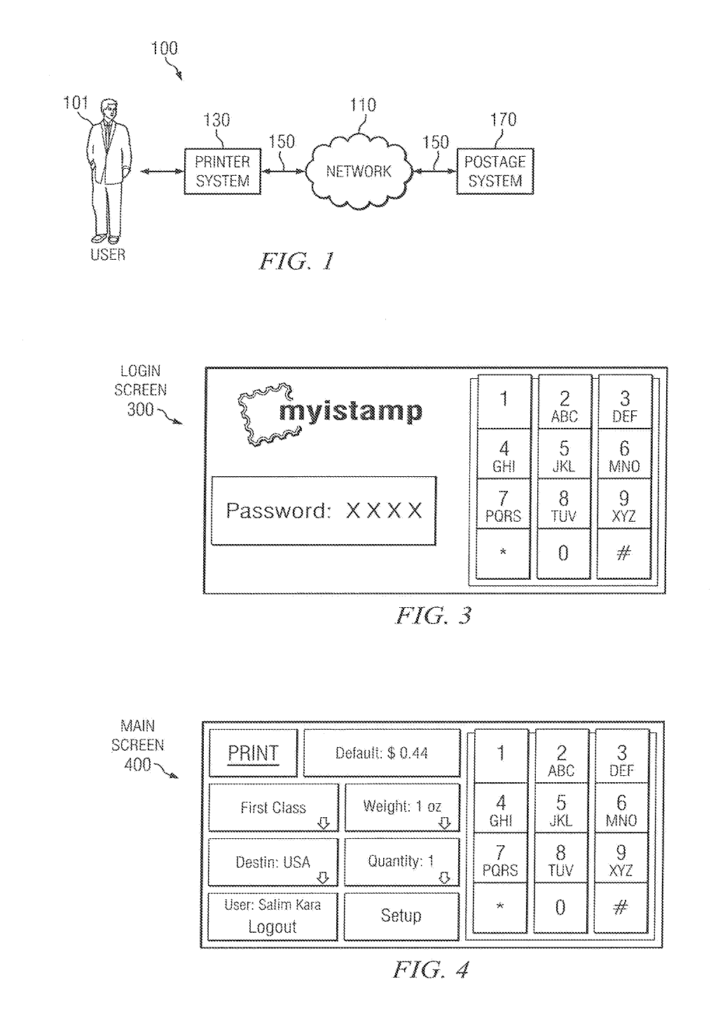

FIG. 1 illustrates an example system 100 for securely providing postage stamps. System 100 includes a user 101, a printer system 130, and a postage system 170 connected to each other by a network 110. Although FIG. 1 illustrates a particular arrangement of user 101, printer system 130, postage system 170, and network 110, this disclosure contemplates any suitable arrangement of user 101, printer system 130, postage system 170, and network 110. As an example and not by way of limitation, printer system 130 and postage system 170 may be connected to each other directly, bypassing network 110. As another example, printer system 130 and postage system 170 may be physically or logically co-located with each other in whole or in part. Moreover, although FIG. 1 illustrates a particular number of users 101, client systems 130, postage systems 170, and networks 110, this disclosure contemplates any suitable number of users 101, client systems 130, postage systems 170, and networks 110. As an example and not by way of limitation, system 100 may include multiple users 101, printer system 130, postage systems 170, and networks 110.

In particular embodiments, postage system 170 may be a network-addressable computing system that can host various postage applications, such as, for example, postage transaction applications, postage security applications, and other suitable postage applications. Postage system 170 may generate, store, receive, and transmit postage information, such as, for example, postage transaction information, postage security information, and other suitable postage information. Postage system 170 may be accessed by the other components of system 100 either directly or via network 110. In particular embodiments, one or more users 101 may use one or more printer systems 130 to access, send data to, and receive data from postage system 170. Printer system 130 may access postage system 170 directly, via network 110, or via a third-party system.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WW AN), a metropolitan area network (MAN), a portion of the Internet, a portion of the Public Switched Telephone Network (PSTN), a cellular telephone network, or a combination of two or more of these. Network 110 may include one or more networks 110.

Connections 150 may connect printer system 130 and postage system 170 to communication network 110 or to each other. This disclosure contemplates any suitable connections 150. In particular embodiments, one or more connections 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)) or optical (such as for example Synchronous Optical Network (SONET) or Synchronous Digital Hierarchy (SDH)) connections. In particular embodiments, one or more connections 150 each include an ad hoc network, an intranet, an extranet, a VPN, a LAN, a WLAN, a WAN, a WWAN, a MAN, a portion of the Internet, a portion of the PSTN, a cellular telephone network, another connection 150, or a combination of two or more such connections 150. Connections 150 need not necessarily be the same throughout system 100. One or more first connections 150 may differ in one or more respects from one or more second connections 150.

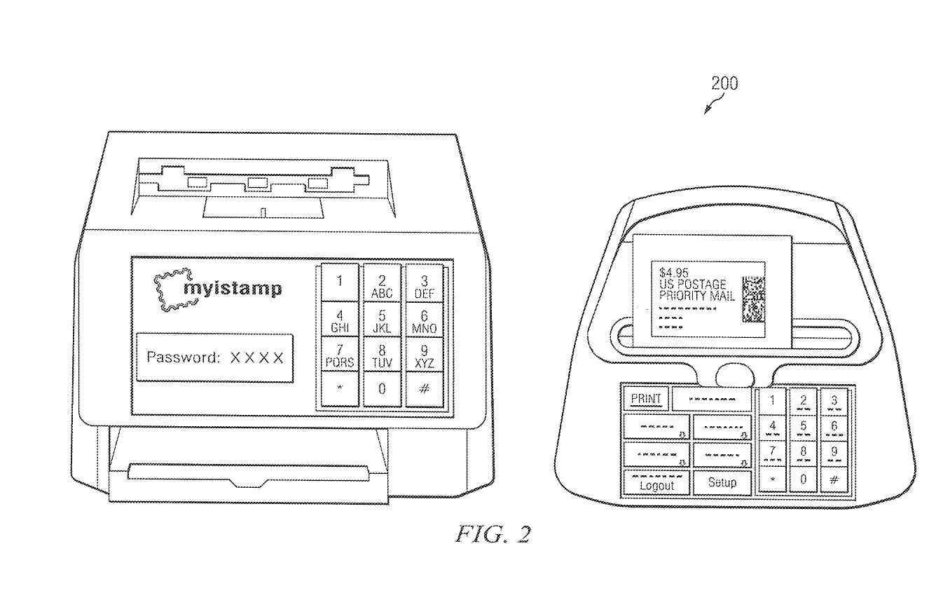

FIG. 2 illustrates two example postage stamp printers 200. In particular embodiments, a printer system 130 may include one or more postage stamp printers 200. The postage stamp printer 200 may include a printer, a display, a user interface, and a network interface. FIG. 2 illustrates an example postage stamp printer 200 that is a laser printer and another example postage stamp printer 200 that is a label printer, however, although FIG. 2 illustrates postage stamp printer 200 as a particular type of printer system, this disclosure contemplates postage stamp printer 200 as any suitable type of printer system.

In particular embodiments, a postage stamp printer 200 may include a printer. The printer may be any suitable type of printer, such as, for example, a dot-matrix printer, an ink-jet printer, a solid ink printer, a dye-sublimation printer, a laser printer, a thermal printer, another suitable printer, or two or more such printers. The printer may print on any suitable media, such as, for example, sheet paper, printer paper, plotter paper, photo paper, paper rolls, printer label rolls, label sheets, boxes, parcels, another suitable media, or two or more such media. As an example and not by way of limitation, the printer may be used to print postage indicia (e.g., postage stamps). As another example and not by way of limitation, the printer may be used as a label printer. As yet another example and not by way of limitation, the printer may be used as a standard printer.

In particular embodiments, a postage stamp printer 200 may include a network interface. The network interface may be any suitable type of network interface, such as, for example wireless or Ethernet based. The postage stamp printer 200 may use the network interface to connect with other systems via any suitable connection, such as, for example, a connection 150.

In particular embodiments, a postage stamp printer 200 may receive input from a scale for automatic weight input. As an example and not by way of limitation, a user 101 could place an object (such as, for example, a package or envelope) on the scale, which could weigh the object and transmit the weight of the object to the postage stamp printer 200. The postage stamp printer 200 could then calculate the value of postage needed to mail the object based on the object's weight and other parameters. The scale may be built-in to the postage stamp printer 200 or connected to the postage stamp printer 200 by any suitable connection.

In particular embodiments, a postage stamp printer 200 may be powered by any suitable power source. The postage stamp printer 200 may by powered by an external source (such as, for example, an AC or DC power outlet) or an internal source (such as, for example, rechargeable or non-rechargeable batteries). Although this disclosure describes powering a postage stamp printer 200 using particular power sources, this disclosure contemplates powering a postage stamp printer 200 using any suitable power source 200.

In particular embodiments, a postage stamp printer 200 may include one or more displays. The display may render, visualize, display, message, and publish to one or more users based on output from the postage stamp printer 200. Output from the postage stamp printer 200 can be transmitted to the display by any suitable connection. The display can include any suitable I/O device that can enable communication between a user and display. As an example and not by way of limitation, the display can include a video monitor, speaker, touchscreen, printer, another suitable I/O device, or a combination of two or more of these. Although this disclosure describes and FIG. 2 illustrates a display as a particular type of I/O device, this disclosure contemplates a display as any suitable type of I/O device.

In particular embodiments, a postage stamp printer 200 may receive user-input from one or more users via the display. As an example and not by way of limitation, the display may be a type of touchscreen, such as a resistive touchscreen, a capacitive touchscreen, an infrared touchscreen, or another suitable type of touchscreen. The user may click, touch, or otherwise interact with the display to select and input commands and to perform other actions. Although this disclosure describes and FIG. 2 illustrates a postage stamp printer 200 receiving user-input via a particular component, this disclosure contemplates a postage stamp printer 200 receiving user-input via any suitable I/O interface. As an example and not by way of limitation, a postage stamp printer 200 may receive user-input via keyboard, keypad, microphone, monitor, mouse, printer, scale, scanner, speaker, still camera, stylus, tablet, trackball, video camera, another suitable I/O device, or a combination of two or more of these. As another example, and not by way of limitation, a postage stamp printer 200 may receive user input via a peripheral I/O device, such as a detachable keyboard, keypad, microphone, monitor, mouse, printer, scale, scanner, speaker, still camera, stylus, tablet, trackball, video camera, another suitable I/O device, or a combination of two or more of these.

In particular embodiments, a postage stamp printer 200 may receive user-input from one or more users via a user interface that is displayed on a display. As an example and not by way of limitation, the user interface may be a graphic user interface that allows one or more users to interact with the postage stamp printer 200. A user may click, touch, or otherwise interact with the user interface to provide input to the postage stamp printer 200. The user interface may be generated by any suitable program or application. As an example and not by way of limitation, the user interface may be provided in a structured document and processed by a browser client of the postage stamp printer 200. A user of a postage stamp printer 200 can use the browser client or other application to access a user interface over a network (such as, for example, network 110). The user interface may be automatically generated and presented to the user in response to the user accessing the postage system 170, a third-party website, or executing an application on the postage stamp printer 200. As another example and not by way of limitation, the user interface may be provided by a dedicated client application hosted on the postage stamp printer 200.

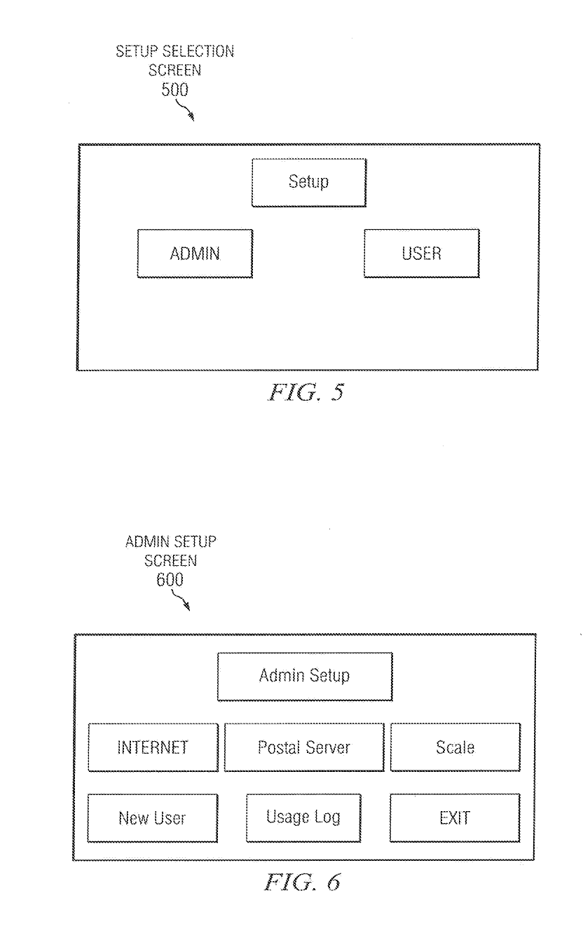

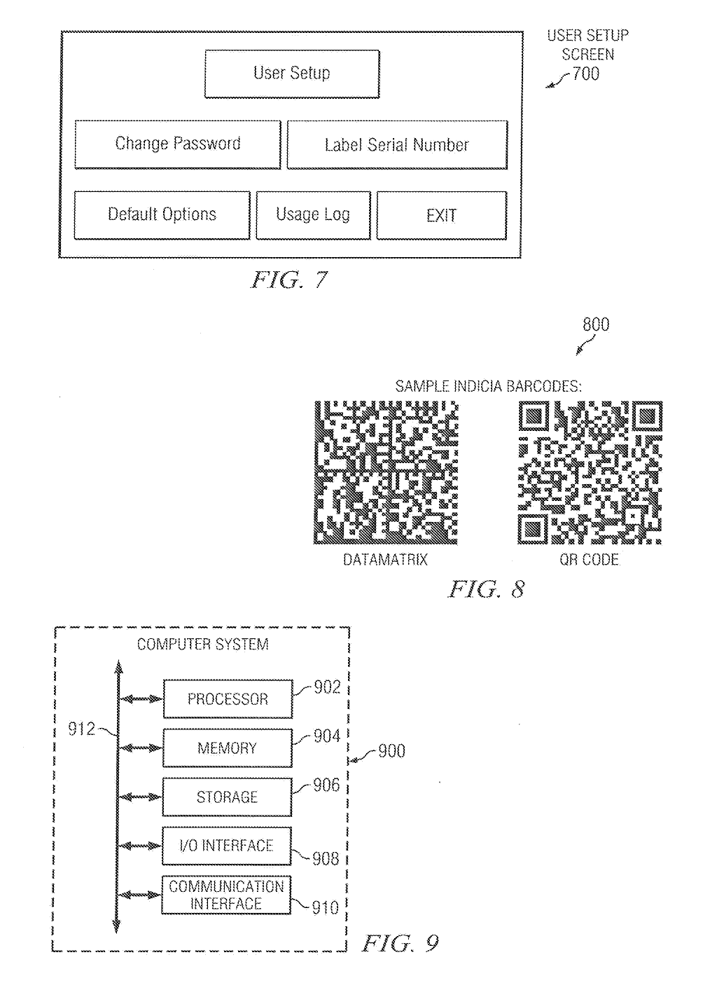

FIGS. 3 thru 7 illustrate example user interfaces. The user interfaces illustrated in FIGS. 3 thru 7 may be displayed on any suitable display on a postage stamp printer 200. FIG. 3 illustrates an example user interface login screen for logging in to a postage stamp printer 200. The login screen includes a graphic keypad for entering alphanumeric characters. In particular embodiments, the postage stamp printer 200 has various security features. As illustrated in FIG. 3, a user may enter a password using the graphic keypad displayed in the user interface. In particular embodiments, a user may be required to enter a user name and/or password to operate the postage stamp printer 200. User names and passwords may be stored locally or on a remote server (such as, for example, postage system 170). User names and password may be stored in any suitable manner, such as, for example, in a database. In particular embodiments, the postage stamp printer 200 may use physical security systems to control access. As an example and not by way of limitation, the postage stamp printer 200 may use physical keys, RFID chips, USB dongles, biometric sensors, or other suitable physical security system to control access to the postage stamp printer 200. FIG. 4 illustrates an example user interface main screen for selecting different postage options. The main screen includes a graphic keypad for entering alphanumeric characters. The main screen also includes various icons for selecting stamp denomination, shipping destination, shipping class, weight, and stamp quantity. The main screen also includes an icon to initiate printing postage indicia. FIG. 5 illustrates an example user interface setup selection screen for setting up a postage stamp printer 200. The setup selection screen allows a user to select setting up administrator and user accounts on the postage stamp printer 200. FIG. 6 illustrates an example user interface admin setup screen for setting up administrator rights and preferences on a postage stamp printer 200. The admin setup screen includes icons for setting up internet access, postage system access, the scale, new user accounts, and usage logs. FIG. 7 illustrates an example user interface user setup screen for setting up user rights and preferences on a postage stamp printer 200. The user setup screen includes icons for setting up user passwords, label serial numbers, default options, and usage logs. Although FIGS. 3 thru 7 illustrate user interfaces with particular arrangements of visual icons and indicators, this disclosure contemplates user interfaces with any suitable arrangement of visual icons and indicators. Moreover, although FIGS. 3-7 illustrate user interfaces that facilitate performing particular functions, this disclosure contemplates user interfaces that facilitate performing any suitable functions.

In particular embodiments, a postage stamp printer 200 may print on-demand stamp. Unlike other postage systems, the postage stamp printer 200 may print on-demand stamps independent from a separate computer. The postage stamp printer 200 may function as a free-standing and/or handheld and self-contained system for printing stamps. The postage stamp printer 200 requires no computer. It may connect, send, receive, and process information directly to/with a remote postage server (such as, for example, postage system 170) to request postage. As an example and not by way of limitation, the remote postage server may generate and transmit postage indicia to the postage stamp printer 200. As an example and not by way of limitation, the remote postage server may generate and transmit postage information to the postage stamp printer 200, which may then generate and print the postage indicia. As yet another example and not by way of limitation, the remote postage server may generate and transmit postage information to a 3rd party system, which may then generate and transmit postage indicia to the postage stamp printer 200.

In particular embodiments, a postage stamp printer 200 may be programmed to setup the following services and features: wireless/wired network connection access; connection to a remote postage server; printer model/serial numbers; IP address; usernames; password; scale settings; default operating settings; and other suitable services and features. The setup of these services and features may be initiated by hardware or software in the postage stamp printer 200. The setup of these services and feature may be performed at any suitable time, such as, for example, upon first activation of the postage stamp printer 200, each time the postage stamp printer 200 is powered up, each time the postage stamp printer 200 is reset, or at other suitable times.

In particular embodiments, a postage stamp printer 200 may be operated remotely. A user 101 may remotely operate the postage stamp printer 200 from any suitable client system, such as, for example, a printer system 130, a postage system 170, a mobile client system (e.g., smart phone, tablet computer, personal digital assistant, etc.), a 3rd party server, another suitable client system, or two or more such client systems. One or more of the features and services available on the postage stamp printer 200 may be accessible during remote operation. As an example and not by way of limitation, a remote user of a postage stamp printer 200 may be able to print postage stamps remotely, but may not be able to edit the user names and password for the postage stamp printer 200 remotely. A remote user may be able to access the postage stamp printer 200 directly for remote operation, via a network 110, via a postage system 170, or via another suitable system. As an example and not by way of limitation, a remote user may be able to access a webpage hosted by a postage system 170, where the user may have access to one or more of the user interfaces displayed in FIGS. 3 thru 7. This may allow the user to perform one or more operations remotely. As an example and not by way of limitation, a remote user may remotely access a postage stamp printer 200 and add/delete new users, edit user names and passwords, set usage limits for one or more users, to set limits and to download usage audit trail by individual, departments, authorize printing of one or more postage stamps.

In particular embodiments, a postage stamp printer 200 may automatically transmit usage logs to one or more systems. As an example and not by way of limitation, a postage stamp printer 200 may automatically upload a usage log to postage system 170 each day. Usage logs may include information on all postage indicia printed from the postage stamp printer 200, the user(s) of the postage stamp printer 200, and other suitable usage information.

In particular embodiments, a postage stamp printer 200 may automatically download postage information from one or more systems. As an example and not by way of limitation, a postage stamp printer 200 may automatically download postage rate schedules from postage system 170. New postage rate schedules may be downloaded at any suitable time. In particular embodiments, postage system 170 may automatically push or transmit postage rate schedules to one or more printer systems 130, such as a postage stamp printer 200. As another example and not by way of limitation, a postage stamp printer 200 may download one or more postage indicia from postage system 170. The postage indicia may be for various values and denominations. The postage indicia may be stored for later printing.

In particular embodiments, a printer system 130 may use a printer media that include various security features. As an example and not by way of limitation, a printer media may include a unique identifier. The unique identifier may be a serial number, an RFID chip, a barcode, another suitable unique identifier, or two or more such identifiers. As an example and not by way of limitation; a serial number may be preprinted on the printer media, inserted into the printer media, or made part of the printer media in whole or in part. The unique identifier may be associated with one or more printer media. As an example and not by way of limitation, a unique identifier may be associated with a single sheet of paper. As another example and not by way of limitation, a unique identifier may be associated with a ream of paper. The serial number may be printed in using any suitable method on any suitable material, such as, for example, ink, toner, tagging, or markings.

In particular embodiments, when a user installs a new printer media in a printer system 130, the user may input the unique identifier of the printer media using a suitable I/O device, such as a keypad, touchpad, a graphical user interface, or another suitable I/O device. In particular embodiments, a printer system 130 may automatically detect the unique identifier for the printer media. As an example and not by way of limitation, a printer label roll may include an RFID that the printer system 130 may automatically detect when the printer label roll is installed. As another example and not by way of limitation, sheet paper may include a barcode that the printer system 130 can scan when the media is installed or as it is utilized. Although this disclosure describes a printer system 130 receiving the unique identifier of a printer media using particular processes, this disclosure contemplates a printer system 130 receiving the unique identifier of a printer media using any suitable processes.

In particular embodiments, a printer system 130 may print the unique identifier of a printer media on a postage stamp. The unique identifier may be printed in whole or in part. In particular embodiments, the printer system 130 may print the unique identifier from the printer media and also print extra digits that may contain additional information (such as, for example, the stamp number, or the printer system 130 serial number).

In particular embodiments, a postage system 170 may use the unique identifier of a printer media to generate postage indicia. As an example and not by way of limitation, the postage system 170 may generate a 2D barcode postage indicia that includes the unique identifier of the printer media for a particular printer system 130. In particular embodiments, the postage system 170 may also include other information in the postage indicia based on information from printer system 130. The postage indicia may include the IP address of the printer system 130, the unique identifier of the printer media in printer system 130, the serial number of printer system 130, the physical location of the printer system 130, and other suitable information.

In particular embodiments, a printer system 130 may print postage indicia that complies with Information Based Indicia (IBI) standards. The printer system 130 may use an inkjet cartridge using special postage ink. The printer system may print an Information Based Indicia, which is a 2-dimensional Data Matrix or bar code combined with visually identifiable characters and symbols. The IBI data matrix may contain such information as amount of postage, origin zip code, destination, mail class, weight, and confirmation/tracking numbers. The IBI bar code and associated printed elements are based on the Post Office's Information Based Indicia Program (IBIP). The indicia may contain numerous data elements, including date, delivery point and digital signature. Some printer systems 130 may rely on software only while others use a hardware key (dongle) or any other secure hardware device that holds the downloaded postal funds.

In particular embodiments, postage indicia may include both security information and advertisement information. A postage indicia may contain a variety of advertisement information, such as, for example, a website address, corporate information, personal information, product information, messages, service information, game information, coupons, pictures, and other advertisement information. The security information and advertisement information may be printed in the same indicia or separately.

FIG. 8 illustrates an example of indicia barcodes. These example indicia barcodes both contain 60 bytes of alphanumeric characters and 10 bytes for an additional tag (such as, for example, an advertisement tag). In these examples, the indicia barcodes contain “adjutr7654nkogrthi5678098765bcp56bgfedo67ads9mvtgolkjr54320z” and the additional tags contain “*ABCD 12345”. In particular embodiments, the indicia barcodes comply with particular Information Based Indicia standards, such as those provided by the United States Postal Service.

In particular embodiments, a printer system 130 may print a separate tag to alert a user about advertisement information in postage indicia.

In particular embodiments, the advertisement information is a randomly generated number or other identifier that may be linked to a particular coupon or prize.

In particular embodiments, the advertisement information may be based on user information, demographic information, or other suitable criteria.

In particular embodiments, the advertisement information may be human readable or digitally signed. The advertisement information may be encrypted.

In particular embodiments, the postage indicia may be scanned by an optical reader. The optical reader may be a 2D barcode/CCD scanner, a cell phone, a personal digital assistant, a computer, a laptop, a netbook, a tablet computer, or another suitable client system. In particular embodiments, the optical reader may utilize a particular application for scanning the indicia where the application may display the advertisement information. As an example and not by way of limitation, a user may scan a 2D barcode postage indicia with a smartphone containing a suitable application, and the application may reveal the advertisement information in the 2D barcode. The advertisement information may include prizes, coupons, and associated terms, conditions and redeeming instructions.

In particular embodiments, user information from a printer system 130 may be data mined. As an example, and not by way of limitation, a postage system 170 may access one or more printer systems 130 and download the user information from the printer systems 130. This user information may then be analyzed in order to generate customized advertisement information for particular users.

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes mam memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include an HDD, a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both providing one or more interfaces for communication between computer system 900 and one or more I/O devices. Computer system 900 may include one or more of these I/O devices, where appropriate. One or more of these I/O devices may enable communication between a person and computer system 900. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more 110 interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example, and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 902 (such as, for example, one or more internal registers or caches), one or more portions of memory 904, one or more portions of storage 906, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JA VA. In particular embodiments, software is expressed in Hyper Text Markup Language (HTML), Extensible Markup Language (XML), or other suitable markup language.

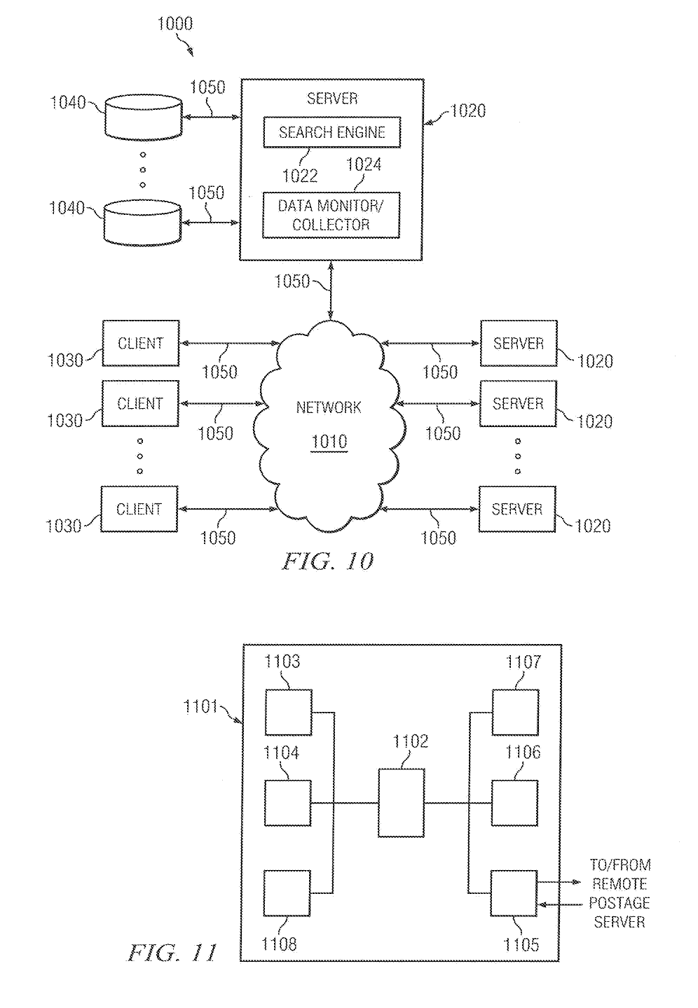

FIG. 10 illustrates an example network environment 1000. This disclosure contemplates any suitable network environment 1000. As an example and not by way of limitation, although this disclosure describes and illustrates a network environment 1000 that implements a client-server model, this disclosure contemplates one or more portions of a network environment 1000 being peer-to-peer, where appropriate. Particular embodiments may operate in whole or in part in one or more network environments 1000. In particular embodiments, one or more elements of network environment 1000 provide functionality described or illustrated herein. Particular embodiments include one or more portions of network environment 1000. Network environment 1000 includes a network 1010 coupling one or more servers 1020 and one or more clients 1030 to each other. This disclosure contemplates any suitable network 1010. As an example and not by way of limitation, one or more portions of network 1010 may include an ad hoc network, an intranet, an extranet, a virtual private network (VPN), a local area network (LAN), a wireless LAN (WLAN), a wide area network (WAN), a wireless WAN (WW AN), a metropolitan area network (MAN), a portion of the Internet, a portion of the Public Switched Telephone Network (PSTN), a cellular telephone network, or a combination of two or more of these. Network 1010 may include one or more networks 1010.

Links 1050 couple servers 1020 and clients 1030 to network 1010 or to each other. This disclosure contemplates any suitable links 1050. As an example and not by way of limitation, one or more links 1050 each include one or more wireline (such as, for example, Digital Subscriber Line (DSL) or Data Over Cable Service Interface Specification (DOCSIS>>, wireless (such as, for example, Wi-Fi or Worldwide Interoperability for Microwave Access (WiMAX) or optical (such as, for example, Synchronous Optical Network (SONET) or Synchronous Digital Hierarchy (SDH)) links 1050. In particular embodiments, one or more links 1050 each includes an intranet, an extranet, a VPN, a LAN, a WLAN, a WAN, a MAN, a communications network, a satellite network, a portion of the Internet, or another link 1050 or a combination of two or more such links 1050. Links 1050 need not necessarily be the same throughout network environment 1000. One or more first links 1050 may differ in one or more respects from one or more second links 1050.

This disclosure contemplates any suitable servers 1020. As an example, and not by way of limitation, one or more servers 1020 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, a server 1020 includes hardware, software, or both for providing the functionality of server 1020. As an example and not by way of limitation, a server 1020 that operates as a web server may be capable of hosting websites containing web pages or elements of web pages and include appropriate hardware, software, or both for doing so. In particular embodiments, a web server may host HTML or other suitable files or dynamically create or constitute files for web pages on request. In response to a Hyper Text Transfer Protocol (HTTP) or other request from a client 1030, the web server may communicate one or more such files to client 1030. As another example, a server 1020 that operates as a mail server may be capable of providing e-mail services to one or more clients 1030. As another example, a server 1020 that operates as a database server may be capable of providing an interface for interacting with one or more data stores (such as, for example, data stores 1040 described below). Where appropriate, a server 1020 may include one or more servers 1020; be unitary or distributed; span multiple locations; span multiple machines; span multiple datacenters; or reside in a cloud, which may include one or more cloud components in one or more networks.

In particular embodiments, one or more links 1050 may couple a server 1020 to one or more data stores 1040. A data store 1040 may store any suitable information, and the contents of a data store 1040 may be organized in any suitable manner. As an example and not by way or limitation, the contents of a data store 1040 may be stored as a dimensional, flat, hierarchical, network, object-oriented, relational, XML, or other suitable database or a combination or two or more of these. A data store 1040 (or a server 1020 coupled to it) may include a database-management system or other hardware or software for managing the contents of data store 1040. The database-management system may perform read and write operations, delete or erase data, perform data deduplication, query or search the contents of data store 1040, or provide other access to data store 1040.

In particular embodiments, one or more servers 1020 may each include one or more search engines 1022. A search engine 1022 may include hardware, software, or both for providing the functionality of search engine 1022. As an example and not by way of limitation, a search engine 1022 may implement one or more search algorithms to identify network resources in response to search queries received at search engine 1022, one or more ranking algorithms to rank identified network resources, or one or more summarization algorithms to summarize identified network resources. In particular embodiments, a ranking algorithm implemented by a search engine 1022 may use a machine-learned ranking formula, which the ranking algorithm may obtain automatically from a set of training data constructed from pairs of search queries and selected Uniform Resource Locators CURLs), where appropriate.

In particular embodiments, one or more servers 1020 may each include one or more data monitors/collectors 1024. A data monitor/collection 1024 may include hardware, software, or both for providing the functionality of data collector/collector 1024. As an example and not by way of limitation, a data monitor/collector 1024 at a server 1020 may monitor and collect network-traffic data at server 1020 and store the network-traffic data in one or more data stores 1040. In particular embodiments, server 1020 or another device may extract pairs of search queries and selected URLs from the network-traffic data, where appropriate.

This disclosure contemplates any suitable clients 1030. A client 1030 may enable a user at client 1030 to access or otherwise communicate with network 1010, servers 1020, or other clients 1030. As an example and not by way of limitation, a client 1030 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 1030 may be an electronic device including hardware, software, or both for providing the functionality of client 1030. As an example and not by way of limitation, a client 1030 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 1030 may include one or more clients 1030; be unitary or distributed; span multiple locations; span multiple machines; span multiple datacenters; or reside in a cloud, which may include one or more cloud components in one or more networks.

In one example embodiment, as illustrated in FIG. 11, a postage printing apparatus 1101 is provided. Postage printing apparatus 1101 may comprise a housing (as shown, for example, in FIG. 2). The housing may encompass and or support the various elements of the apparatus.

Apparatus 1101 has a controller 1102. Preferably, controller 1102 is housed in and/or supported by the apparatus housing. Controller 1102 may comprise one or more processors, memory devices, and other hardware components, which provide the desired functionality for controller 1102. Preferably, controller 1102 controls the operation of the other electronic components, hardware, modules, etc. of apparatus 1101. As such, controller 1102 is in electronic communication with a printer 1103, a user interface 1104, a postage server communication module 1105, a security module 1106, and an advertising module 1107. The communication path between these elements may be of any suitable type that provides passage of data and/or electronic signals between the components. Thus, the electronic communication may be wired or wireless, via printed circuit boards or other hardware, via network connections, and the like.

Apparatus 1101 may include a printer 1103. Printer 1103 may be built into, or otherwise supported by, the housing as an integral part of apparatus 1101. Printer 1103 is operable to receive printing instructions from any of the other components that may be operable to provide such instructions. In one example, printer 1103 is operable to receive printing instructions from postage server communication module 1105 via, for instance, controller 1102. The printing instructions may comprise data or other electronic signals that instruct the printer 1103 to function and instruct printer 1103 as to what to print and upon what medium. Printer 1103 may be any suitable type of printer that is operable to print postage indicia. Thus, printer 1103 may be a laser printer, an ink jet printer, or another type of printer that is capable of printing the postage indicia on any suitable type of postage stock, such as postcards, envelopes, labels, or the like. It should be understood that term postage stock can refer to any type of media on which postage indicia may be printed.

Apparatus 1101 may also include a user interface 1104. User interface 1104 is preferably operable to receive input from one or more users. User interface 1104 may have any suitable configuration such as, for example, the configurations illustrated in FIGS. 2-7. The precise functionality of user interface 1104 has been previously described in connection with FIGS. 2-7. Preferably, user interface 1104 accepts input that generates a postage request. The postage request may comprise data that represents a variety of postage criteria and or queries. The criteria may include, for example, postage class, destination and origin information, weight, quantity, postage denomination, user identification and account information, client billing codes, and the like. The queries may include, for example, weight, postage rates, destination information, audit information, and the like. User interface 1104 may also provide various administrative, setup, and operation functionality to the user as previously discussed. User interface 1104 is preferably operable, via controller 1102 for example, to send information queries to other components of apparatus 1101 and to receive answers to the those queries. User interface 1104 is also preferably operable to send instructions to other components of apparatus 1101. For example, user 1104 is preferably operable to send a postage request to postage server communication module 1105 for further transmission to a remote postage server (not expressly shown). In at least one embodiment, user interface 1104 may be configured to be detachable from the housing of apparatus 1101. The detachable user interface 1104 may be provided with wireless communication capability such that a remote user may remotely control apparatus 1101. Preferably, in the case of remote usage of apparatus 1101, the remote usage is only enabled if certain criteria are met. These criteria may include user identification information (which may be, for example, biometric information) and/or user proximity information such as distance between the user and apparatus 1101.

Apparatus 1101 may also include a postage server communication module 1105. Postage server communication module 1105 may be operable to transmit and receive messages, data, information, instructions, and the like to and from a remote postage server (not expressly shown). The remote postage server may be any suitable postage server, computer, or similar hardware component or system that provides postage criteria, data, instructions, etc. for the creation of postage indicia. Any suitable remote postage server, such as those known in the industry may be used. Postage server communication module 1105 may accept instructions and queries from any other suitable component of apparatus 1101, such as for example, user interface 1104 via controller 1102. For example, postage server communication module 1105 may receive a user's postage request from user interface 1104. Postage server communication module 1105 may transmit the postage request to the remote postage server. The postage request may comprise data, codes, queries, instructions, and the like, which are relevant to the determination and printing of postage indicia. For example, the postage request may include information determined by the user independently of apparatus 1101, but entered via user interface 1104. The postage request may also include information determined by other components of apparatus 1101, such as, for example, weight information determined by a scale (not expressly shown). The postage request may also include codes, such as account codes and user identification codes. The codes may be embodied in any suitable form, such as usernames, passwords, encryption keys, identification indicia, bar codes, serial numbers, IP addresses, images, biometric data, and the like. Some or all of these pieces of information may be stored in memory 1108 and may be controlled by security module 1106. Postage server communication module 1105 is also preferably operable to receive data, instructions, and the like that comprise answers to queries, postage information criteria and updates, and/or printing instructions for printing postage indicia.

Apparatus 1101 may further include a security module 1106, which may be in electronic communication with the other components of apparatus 1101 via, for example, controller 1102. Security module 1106 may administer, actuate, and/or otherwise control operation of any of the security functions of apparatus 1101. Preferably, security module 1106 is operable to control an access function, according to which access to, and operability of, apparatus 1101 is permitted or denied based on any number of physical or electronic inputs or actions. According to one aspect, security module 1106 is operable to permit access to, and operation of, apparatus 1101 if a physical key is inserted into a key receptacle (not expressly shown) and the key is actuated. In another example aspect, a dongle receptacle may be provided, as part of the housing for instance, and may be operable to receive a dongle. The dongle may be actuated to permit access to, and operation of, apparatus 1101. According to yet another example aspect, security module 1106 is operable to unlock the postage printing apparatus in response to the presence of a radio frequency identification (“RFID”) device. For instance, the RFID device may transmit a code to a receiver within apparatus 1101. If the code is suitable, or otherwise matches a corresponding code stored, for example, in a memory module 1108 within apparatus 1101, access to and operation of apparatus 1101 may be permitted. The RFID device may have encoded therein other information relevant to the operation of apparatus 1101, such as account codes, serial numbers, account values, postage criteria, user data, user identification information, audit information, and the like, which may be transmitted to a corresponding receiver in, attached to, or otherwise in communication with apparatus 1101. Security module 1106 may also comprise or be connected to a biometric sensor. The biometric sensor may be any suitable sensing device that monitors or reads biometric information. Such information may include, for example, fingerprint information, DNA information, retina scanning information, facial recognition information, and the like. The biometric information may be used by security module 1106 and/or communicated to other components of apparatus 1101 to permit or deny access to, and operation of, apparatus 1101. Security module 1106 may also include, or be connected to, a geo-tagging device or module. The geo-tagging module may provide or receive geographic data, such as global positioning satellite (“GPS”) data, which corresponds to the location of apparatus 1101, user interface 1104, or a user. The geo-tagging module or device may be operable to permit or deny usage of apparatus 1101 if apparatus 1101 is positioned in certain locations or if a user of apparatus 1101 is in a certain location. Alternatively, usage may be permitted only if a user is within a certain perimeter of apparatus 1101. Thus, for example, if a remote user is beyond a certain predetermined distance from apparatus 1101, then the user may be denied access to, or operation of, apparatus 1101. The geo-tagging module may also be operable to determine the location where the postage indicia is printed. Such information may be stored in the memory 1108, or transmitted to another device or application (not expressly shown).

Apparatus 1101 may also include an advertisement module 1107, which may be in electronic communication with the other components of apparatus 1101, for example via controller 1102. Advertisement module 1107 is preferably operable to provide one or more instructions and/or data to printer 1103 for printing advertisement information in conjunction with postage indicia. The advertisement information may take any number of suitable forms. For instance, the advertising media may comprise a website address or link, such as a hyperlink or other link to an Internet website or web page. Thus, if the advertisement information is in an electronic display form, a user may be able to click on the website link to generate an Internet connection to the particular website. If the website information is in a non-electronic form (e.g., printed with ink on postage stock or directly printed on an envelope), then a user may use the website information to later enter that information on a personal computer or smart phone, for example, to access that particular website. According to another example aspect, the advertisement information may comprise a message regarding a product or service. The message may be a corporate message, corporate information, personal message, picture, text, alert, symbols, and the like. According to still another example aspect, the advertisement information may comprise a coupon. The coupon may be redeemable, for example, for goods or services at a discount. According to another example aspect, the advertisement information may be in the form of a game. The advertisement information may be a scratch-off game such as a scratch-off lottery game, for example. According to another example aspect, the advertisement information may comprise a code corresponding to a prize. The advertisement information may be any indicia operable to interact with software, such as an application running on a smart phone. For example, the smart phone may be able to scan the advertisement indicia and input the indicia into an application to effect some predetermined action, such as awarding a prize or making an offer to the user. Of course, it will be understood that that application may be running on any computing platform or independent device having one or more processors running the application. In at least some embodiments, the advertisement information is determined based on demographics or geography, such as demographic information associated with the user of postage printing apparatus 1101, geographic information associated with the location of postage printing apparatus 1101 or based on the destination address.

Postage printing apparatus 1101 may also comprise a memory module 1108, which itself may comprise one or more memories. Any suitable memory may be used. The memory may take the form of one or more databases, memory chips, etc. as long as the memory is capable of storing electronic data. Preferably, memory module 1108 is in electronic communication with other elements of apparatus 1101 via, for example, controller 1102. Memory module 1108 may store any information associated with any of the functionality of apparatus 1101. For example, memory module 1108 may store user information such as user identification information, usernames, passwords, account information, and the like. Memory module 1108 may store postage criteria such as postage amounts, codes, destination and origination information, weights, sizes, denominations, quantities, address information, and the like. Memory module 1108 may also store, for example, component and system information such as serial numbers, hardware identification codes, printer stock codes, and the like.

In certain embodiments, postage printing apparatus 1101 prints directly onto postage stock that contain mail and which may be placed into the mail, such as a package, envelope, postcard, etc. In other embodiments, postage printing apparatus 1101 prints postage indicia on separate postage stock such as a label, or a portion of a label roll, or other separate media, which may then be affixed to an item being mailed. The postage stock may have codes printed thereon, embedded therein, or otherwise associated therewith. The codes may correspond to other data such as information entered by a user via user interface 1104, account codes, passwords, etc. In this way, use of particular postage stock can be limited to authorized users.

By way of example only, operation of the postage printing apparatus 1101 will now be described. It should be understood that this is an example, and various modifications of steps and/or the elimination or addition of steps, are within the scope of the described embodiments.

A user decides to send a letter or other item via mail. The user wishes to print a stamp to affix to the envelope. The user enters applicable postage information by using the user interface 1104. In this example, the user enters the class of mail, such as “first class,” and the type of parcel to be mailed, such as a “letter.” The user weighs the letter on a scale and enters the weight via user interface 1104. The user also enters destination information such as a zip code. The user also enters identification information such as a username and password. Of course, any applicable postage information may be entered as discussed elsewhere. Controller 1102 processes the user-entered information and any additional information automatically supplied to apparatus via other components (such as, for example, location data from security module 1106, or stored postage rates from memory module 1108) and generates a user postage request. Controller 1102 sends the postage request to postage server communication module 1105, which prepares a message containing the request. Postage server communication module 1108 sends the message to a remote postage server. The remote postage server verifies the user's identity and authority to operate postage printing apparatus 1101. Then the remote postage server processes the postage request to determine the appropriate postage, including denomination, amount, and postage format. Then, the remote postage server returns either postage indicia in electronic form, a message containing postage indicia, or instructions which are executed by one or more components of postage printing apparatus 1101 to create or print postage indicia. In this particular example, the remote postage server returns instructions for generating the appropriate postage indicia. Postage server communication module 1105 receives the instructions from the remote postage server and passes the information to controller 1102. Controller 1102 processes the instructions and initiates printing of the postage indicia by printer 1103. Printer 1103 prints a postage label from postage stock within postage printing apparatus 1101. The label is printed with the appropriate postage indicia. The user removes the label and affixes it to the envelope being mailed.

In certain embodiments, the advertisement module 1107 causes the printer advertisement information, such as a coupon, on the label or on another separate postage stock media. In one example, advertisement module 1107 reads the user-entered information to determine which advertisement information to send to the printer. For example, if the destination is Aspen, Colo., and if it is winter, then the advertisement module 1107 may retrieve, from memory module 1108, one of a set of alternative pieces of advertisement information that are particularly applicable to the Aspen, Colo. area. Thus, for instance, advertisement module 1107 might retrieve coupon information for a 50% discount on ski rentals at a particular ski shop in Aspen. The coupon information is forwarded printer 1103 for printing on the label. The recipient of the letter can then use the envelope as a coupon for receiving the discount at the ski shop.

It should be noted that the operation of the various components of postage printing apparatus 1101 may be altered such that different components perform different functions described herein. Thus, for example, processing of user-entered information to generate a postage request may occur in postage server communication module 1105 rather than in controller 1102. This is just an example alteration, and the operation of other components may be modified to include or delete certain functionality.

In accordance with certain embodiments, postage printing apparatus 1101 provides certain functionality. Thus, postage printing apparatus 1101 preferably operates via a direct communication link through a network such as the Internet, with a remote postage server. The remote postage server is owned, operated, hosted, provided, or otherwise controlled by the United States Postage Service or some other postage provider. The connection between postage printing apparatus 1101 and the remote postage server preferably does not include a separate stand-alone, office computer as can be found in current systems. Thus, there is preferably no separate computer (PC, laptop, MAC, etc.) between postage printing apparatus 1101 and the network (e.g., Internet) through which the postage printing apparatus 1101 communicates with the remote postage server. Therefore, operation of the postage printing apparatus 1101 does not cause any interruption of other office computer functions.

The postage printing apparatus 1101 receives postage indicia, or data to generate postage indicia, from the remote postage server and prints the indicia via printer 1103, which is preferably a general-purpose printer. Postage printing apparatus 1101 preferably provides on-demand printing of stamps, labels, or directly-applied postage indicia independent of any separate computer. “Direct communication” between postage printing apparatus 1101 and the remote postage server refers to a direct link between these two hardware components without any separate computer controlling any functionality in the postage printing process other than simply communicating data between the postage printing apparatus 1101 and the remote postage server. Thus, postage printing apparatus 1101 is preferably free-standing and self-contained.

Postage printing apparatus 1101 may incorporate (e.g., in controller 1102 or another suitable component) one or more microchips that may be programmed with setup information for a variety of settings including, without limitation, wireless or wired network connection access, connection to the remote postage server, component serial and model numbers and other identification information (e.g., for the printer), Internet Protocol (IP) addresses, user information, passwords, options (e.g., scale), default settings and the like.

In addition to the features already described elsewhere herein, the user interface 1104 may provide a keypad (e.g., touch screen, LCD, LED, OLED, etc.), which can be detached for remote control. The user interface 1104 provides users with the ability to select from different options (e.g., default, according to stamp denomination, postage classes, etc.) and may provide the user with the ability to generate a postage request. Similarly, the postage printing apparatus 1101 may print postage indicia in various quantities, denominations, postage classes, etc.

Postage printing apparatus 1101 may incorporate various additional components and/or may be connected to any of a number of peripherals. The peripherals may be hard-wired to postage printing apparatus 1101 and/or to a component of postage printing apparatus 1101 such as controller 1102. The connection may also be wireless over, for example, a Bluetooth, WIFI, Direct WIFI, or other connective path or network. One such additional component is a scale for weighing parcels, letters, cards, and any other item to be mailed. The scale may be part of the postage printing apparatus 1101 or may be a separate unit. According to one aspect, the scale may provide automatic input of weight for use in generating a postage request, for use in providing instructions to the printer to print postage indicia, or for any other functionality that uses a weight value. Another peripheral is a computer and/or computer application that receives input from postage printing apparatus to generate user audit trails.

Operation of the postage printing apparatus may be performed manually, remotely, over the web through a website, or according to any other suitable communications and networking technique. In an Internet-based scenario, operation of the postage printing apparatus 1101 and/or printer 1103 is provided through a website account. In at least some embodiments, the postage printing apparatus is accessed and controlled remotely (e.g., through a website) in order to provide administrative capabilities such as adding and deleting users, setting postage use limits, and downloading audit trail information.

Preferably, the postage printing apparatus 1101 through, for example, postage server communication module 1105, receives automatic downloads of any new, or updated, information provided by the remote postage server and stored in the memory module 1108.

Postage printing apparatus 1101 (e.g., through security module 1106, has a variety of security features. Geo-tagging may be used to establish where the postage indicia was printed. Geo-tagging may also be used to control usage of the postage printing apparatus 1101 to within a predetermined perimeter. Security module 1106 may provide for recordable IP addresses. Security module 1106 may also control coordination of code and/or identity verification in connection with user codes, equipment identification numbers, and codes embedded in postage stock or other printing-related materials. Postage stock, such as a label roll, may incorporate a unique serial number that has to be properly authenticated prior to access and use of the stock. An RFID chip, barcode, or other identification device may be embedded in the postage stock to be properly authenticated prior to access and/or use of the stock. The embedded code or serial number may also be pre-printed, inserted, or otherwise incorporated into, in whole or in part, the postage stock through use of special tagging, toner material, marking, etc. To authenticate an embedded code, a user may enter the code (or a corresponding identifier) using, for example, user interface 1104, or by way of an RFID signal transmission, scanning device, or any other suitable security communication platform. Serial numbers or codes, either in whole or in part, may be printed as part of the postage indicia. Additional numbers, symbols, etc. may be added to make each stamp, label or other indicia unique. The serial numbers and codes may be transmitted to the remote postage server and used by the remote postage server to generate indicia and/or create data to be returned to the postage printing apparatus 1101. Other information, such as IP addresses, component serial numbers, and so forth, may be incorporated into the stock and/or the postage indicia.

With regard to the advertisement functionality provide, for example, through the advertisement module 1107, a postage indicia may combine postage security information with advertisement information. This may include, for example, website addresses, corporate information or messages, personal information, messages, product and service descriptions, games, coupons, lotteries, prizes, pictures, etc. A separate “tag” may be printed to alert a user to advertisement information. An advertisement message may include or represent a randomly-generated number linked to a coupon or prize. Advertisement information may be predetermined, or selected, based on any number of criteria, such as demographics, location, usage, and the like. Indicia can be generated in singles, or in multiples. In some cases, the indicia can be scanned by barcode or CCD scanners and/or by cell phones, smart phones, PDAs, tablets, computers, laptops, notebooks, etc. Smart phone applications (or similar applications) may be used by a user to scan indicia, display the public content of the indicia, and link to advertisement media and websites.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in this disclosure to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A postage printing apparatus, comprising:
a user interface operable to receive user input for generating a postage request;
a processor operable to process the user input to generate the postage request;
a postage server communication module in electronic communication with the processor and operable to transmit the postage request to a remote postage server, and receive from the remote postage server postage data for creating a postage indicia;
a printer in electronic communication with the postage server communication module, the printer operable to receive instructions to print the postage indicia.

2. The postage printing apparatus of claim 1, wherein the postage server communication module is in direct communication with the remote postage server through a communications network without a separate computer in the communication link between the postage printing apparatus and the communications network.

3. The postage printing apparatus of claim 2, wherein the communications network is the Internet.

4. The postage printing apparatus of claim 1, further comprising a controller in electronic communication with the user interface, the postage server communication module, and the printer, and wherein the controller is operable to control the functions of the user interface, the postage server communication module, and the printer.

5. The postage printing apparatus of claim 1, further comprising a housing, wherein the user interface is supported by the housing, and is detachable from the housing and operable to remotely provide the user input to the processor.

6. The postage printing apparatus of claim 1, further comprising a memory module in which is store data provided by the remote postage server, and wherein the memory module is operable to receive automatic updates of the data from the remote postage server.

7. The postage printing apparatus of claim 1, further comprising a security module operable to prevent unauthorized use of the postage printing apparatus.

8. The postage printing apparatus of claim 7, wherein the security module is operable to unlock the postage printing apparatus in response to the presence of a radio frequency identification device.

9. The postage printing apparatus of claim 7, further comprising a key receptacle, wherein the security module is operable to unlock the postage printing apparatus in response to activation of the key receptacle.

10. The postage printing apparatus of claim 7, further comprising a dongle receptacle, wherein the security module is operable to unlock the postage printing apparatus in response to insertion of a dongle in the dongle receptacle.

11. The postage printing apparatus of claim 7, further comprising a biometric sensor, wherein the security module is operable to unlock the postage printing apparatus in response to information received by the biometric sensor.

12. The postage printing apparatus of claim 1, further comprising a geo-tagging module operable to prevent operation of the postage printing apparatus beyond a predetermined geographical area.

13. The postage printing apparatus of claim 1, further comprising a geo-tagging module operable to identify the location at which the postage indicia is printed.

14. The postage printing apparatus of claim 1, wherein the user interface is operable to receive input wirelessly communicated from an intelligent communication device.

15. The postage printing apparatus of claim 1, further comprising a memory operable to store a code, and wherein the user interface is operable to receive input of the code to permit operation of the postage printing apparatus.

16. The postage printing apparatus of claim 1, wherein the apparatus is operable to receive postage stock, and wherein an identification code is embedded in the postage stock.

17. The postage printing apparatus of claim 16, wherein the user interface is operable to receive input of the identification code to permit operation of the postage printing apparatus.

18. The postage printing apparatus of claim 16, wherein the apparatus is operable to print the postage indicia on a portion of the postage stock, and wherein at least a portion of the identification code is printed on the portion of the postage stock when the postage indicia is printed.

19. The postage printing apparatus of claim 16, wherein the identification code comprises a user Internet Protocol address.

20. The postage printing apparatus of claim 16, wherein the identification code comprises a serial number corresponding to a predetermined postage stock.

21. The postage printing apparatus of claim 16, wherein the identification code comprises information corresponding to the identity of the postage printing apparatus.

22. The postage printing apparatus of claim 1, further comprising an advertising module operable to cause the printer to print advertisement information with the postage indicia.

23. The postage printing apparatus of claim 22, wherein the advertisement information comprises a website address.

24. The postage printing apparatus of claim 22, wherein the advertisement information comprises a message regarding a product or service.

25. The postage printing apparatus of claim 22, wherein the advertisement information comprises a coupon.

26. The postage printing apparatus of claim 22, wherein the advertisement information comprises a code corresponding to a prize.

27. The postage printing apparatus of claim 1, further comprising a memory operable to store one or more postage values for use in future printing of postage indicia.

28. The postage printing apparatus of claim 1, wherein the postage printing apparatus is operable to transmit information corresponding to a usage audit trail to an audit application.

29. A postage printing apparatus, comprising:
a processor operable to receive postage criteria to generate the postage request;
a postage server communication module in electronic communication with the processor and operable to transmit the postage request to a remote postage server, and receive from the remote postage server postage data for creating a postage indicia, wherein the postage server communication module is in direct Internet communication with the remote postage server;
a printer in electronic communication with the postage server communication module, the printer operable to receive instructions to print the postage indicia.

30. A method of printing postage indicia, comprising:
receiving user input of one or more postage criteria;
using the one or more postage criteria to generate a postage request;
transmitting the postage request directly to a remote postage server;
receiving, directly from the postage server, postage indicia data; and
using the postage indicia data to print a postage indicia.
